(19) United States
(12) Patent Application Publication
(10) Pub. No.: US 2004/0130267 A1
(43) Pub. Date: Jul. 8, 2004

(54) Plasma display panel

(76) Inventors: Hiroshi Kajiyama, Kodaira (JP); Akira Katou, Mito (JP); Ken-Ichi Onisawa, Hitachinaka (JP); Tetsuro Minemura, Hitachioota (JP); Kazuo Uetani, Nishinomiya (JP); Yasushi Ihara, Takarazuka (JP); Shiro Takigawa, Kyoto (JP); Kouichi Nose, Osaka (JP); Isao Tokomoto, Ikeda (JP); Yasuhiro Koizumi, Nishinomiya (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/728,949

(22) Filed: Dec. 8, 2003

Related U.S. Application Data
(63) Continuation of application No. 09/944,147, filed on Sep. 4, 2001.

(30) Foreign Application Priority Data
Sep. 29, 2000 (JP) 2000-338357

(51) Int. Cl. H01J 17/49

(52) U.S. Cl. 313/582; 313/587

(57) ABSTRACT

In a plasma display panel of AC type, consisting of a front panel 9 provided with display electrodes 7 and a rear panel 4 provided with address electrodes 3, that displays an image by causing discharge in the discharge gas space formed between the front panel 9 and rear panel 4, a protective film 5 made of metallic oxide covering a dielectric layer 6 placed on the front panel 9 is formed as follows. The protective film 5 is formed into a structure where columnar structures are densely packed, closely with each other, extending perpendicularly to the interface between the dielectric layer 6 and the protective film 5, and more than 400 columnar structures are formed per the substrate area of 1 μm².

### BACKGROUND OF THE INVENTION

The present invention relates to a plasma display panel, particularly to a plasma display panel that is provided with an electrode protective film having superior crystal form and high electrical property.

The electrode protective film employed on a plasma display panel is required to have some specific characteristics including the sputter resistance against the impact of ions in the discharge gas and high-efficiency secondary emission characteristic resulting from the collision of ions.

A major conventional method of forming the electrode protective film has been the electron beam deposition method as described on pages 54-58 of monthly journal “Display” February 2000 issue. According to the description there, the number of columnar crystals per unit substrate area and crystal orientation depend upon the oxygen pressure during the film forming.

### SUMMARY OF THE INVENTION

Meantime, it is understood that the characteristics required of the electrode protective film of the plasma display panel, including the sputter resistance against the impact of ions in the discharge gas and high-efficiency secondary emission characteristic resulting from the collision of ions are affected by the electrode protective film. That is, the characteristics are affected by the number density of the columnar structures forming the protective film.

In the electrode protective film for the plasma display panel that is formed on the basis of the conventional electron beam deposition method, however, it is found that the columnar structures comprising the film are formed into larger structures and the structures are less minute and that the film itself lacks in physical and chemical stability.

Besides, in the electrode protective film for the plasma display panel formed by the conventional method, it is understood that the lower physical strength of the metallic oxide with low crystallinity formed near the interface with the substrate on which the film is to be formed is one of the causes of preventing the protective film from being made much thinner. For this reason, it is thought desirable that the film itself has high physical stability and that favorable crystals grow directly from the surface of the substrate surface.

Furthermore, since the characteristics required of the electrode protective film of the plasma display panel may possibly be affected by the crystal orientation forming the protective film, there may be a case where it is desirous that a specific crystal orientation is predominant. The crystal orientation mentioned here means that, when explaining, for example, in case of the orientation <111>, the crystal axis along the normal of the substrate is <111>. Besides, the ratio of the orientation <111> is defined as the ratio of the diffraction peak strength by the crystal face <111> over the sum of all diffraction peak strengths by other crystal faces, obtained from the X-ray diffraction measurement.

According to the prior art, it happens that an attempt to form a film having higher ratio of a specific crystal orientation by adjusting the film forming condition properly results in a less minute film with low number density of the columnar structures. Because of this, there has been a problem that both requirements, minute columnar structures and high ratio of desired specific crystal orientation, cannot be met at the same time.

An object of the present invention is to offer a plasma display panel equipped with the electrode protective film having excellent characteristics including the sputter resistance and the secondary emission characteristic.

As a result of a study about the crystal structures of the film made of metallic oxide, it is found that, in order to increase the physical stability of the film and improve the performance as the electrode protective film of a plasma display panel, reducing the thickness of the columnar structures comprising the film and forming more minute structures are desired. It is also found desirous to be able to control the crystal axis along the normal on the substrate surface and still form the minute structures.

From the view point as above, the plasma display panel according to the present invention is a plasma display panel of AC type consisting of a front panel provided with display electrodes and a rear panel provided with address electrodes, that displays an image by causing discharge in the discharge gas space formed between the front and rear panels; the display panel being provided with a protective film made of metallic oxide covering the dielectric layer of the front panel; the protective film being formed into a structure where columnar structures are densely packed, closely with each other, extending perpendicularly from the interface between the dielectric layer and the protective film; and more than 400 columnar structures being formed per the substrate area of 1 μm².

Besides, the number of the columnar structures can be more than 500 per 1 μm². The columnar structures comprising the protective film can be formed into a series of crystal structures from the interface with the substrate to the film surface. Further, magnesium oxide can be selected as the metallic oxide forming the protective film.

With the plasma display panel according to the present invention where the protective film is formed as above, favorable characteristics for the operation of an AC plasma display panel, such as higher sputter resistance, can be realized because the structures of the protective film are minute. Accordingly, with the plasma display panel according to the present invention, the protective film thickness can be less than 300 nm.

The protective film to be formed on the plasma display panel according to the present invention can be structured with one or more crystal axes, selected among a group of <111>, <220>, <100> and <311>, along the normal on the substrate surface (claim 6). Accordingly, the secondary emission coefficient of the protective film can be greater.

In addition to the afore-mentioned sputter resistance and secondary emission coefficient required of the protective film covering the dielectric layer of the plasma display panel, an electric charge storage capacity is also required. When the bias voltage is applied to the display electrode of the AC plasma display panel, electric charge is stored in the protective film surface. The discharge breakdown voltage and discharge extinction voltage depend upon the electric charge storage. If the electric charge storage in the AC plasma display panel is greater, the discharge breakdown voltage decreases and also the operation margin voltage defined by the difference between the discharge breakdown voltage and the discharge extinction voltage increases.

For the reasons above, improving the electric charge storage capacity of the protective film is desirous for highly efficient and stable discharge of the AC plasma display panel. The electric charge storage capacity of the protective film depends remarkably upon the electric resistance of the protective film. Generally speaking, the electric resistance varies depending upon the impurity concentration in the film. The electric resistance depends also on the film thickness and increases as the film thickness decreases. Since the protective film covering the dielectric layer of the plasma display panel according to the present invention has high crystallinity throughout the film surface, it is easy to control the electric resistance, i.e. the electric charge storage capacity by controlling both impurity concentration and film thickness.

### BRIEF DESCRIPTION OF DRAWINGS

FIG. 1 is a view showing a portion corresponding to a picture element of the AC plasma display panel;

FIG. lb is a cross-sectional view of a line I-I in FIG. 1a;

FIG. 2a is a microscopic picture showing an observed image of the surface of the protective film of the embodiment 1;

FIG. 2b is a microscopic picture showing an observed image of the surface of the protective film of the embodiment 2;

FIG. 3 is a microscopic picture showing an observed image of the surface of the protective film of the comparative sample;

FIG. 4a is a microscopic picture showing observed images of the surface and cross-section of the protective film of the embodiment 1;

FIG. 4b is a microscopic picture showing observed images of the surface and cross-section of the protective film of the embodiment 2;

FIG. 5 is a microscopic picture showing observed image of the surface and cross-section of the protective film of the comparative sample;

FIG. 6a is a schematic diagram of the secondary emission characteristic evaluating device;

FIG. 6b is a chart showing the measurement result of the secondary emission characteristic.

### DETAILED EXPLANATION OF THE PREFERRED EMBODIMENTS OF THE INVENTION

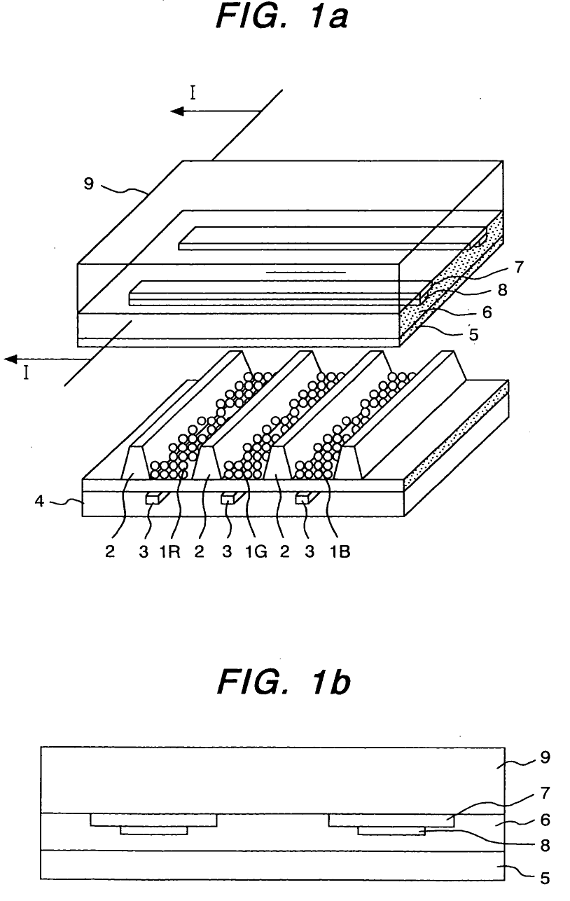

The embodiment of the present invention is explained hereunder, using FIG. 1. FIG. 1 is an enlarged view of a picture element of an AC plasma display panel according to an embodiment of the present invention. FIG. 1a is an elevation view and FIG. 1b is a sectional view of I-I in FIG. 1a.

The plasma display panel consists of a front panel 9 and a rear panel 4 facing each other as shown in FIG. 1 a. The rear panel is provided with three different luminescent materials 1R, 1G and 1B for displaying the picture element, separated from each other by partitions 2. It is so designed that the picture element is displayed in any color by means of the three luminescent materials 1R, 1G and 1B.

In addition, the rear panel 4 is provided with address electrodes 3 arranged along the Y axis. Each address electrode 3 corresponds to each of the three different luminescent materials.

The front panel 9 is provided with display electrodes 7 along the X axis perpendicularly to the address electrodes 3. The display electrodes 7 are provided with bus electrodes along the same direction. Generally, the display electrodes 7 are transparent and the bus electrodes 8 are made of metal.

The display electrodes 7 and bus electrodes 8 are provided as embedded in a dielectric layer 6. The dielectric layer 6 can be made of lead glass. Then, a protective film 5 is provided on the surface of the dielectric layer 6. Detailed description of the protective film 5 is given later.

The discharge gas space formed between the front panel 9 and the rear panel 4 is filled with discharge gas, which is neon (Ne) and xenon (Xe) with specified pressure and mixture. When a specified drive voltage is applied to the address electrodes 3, display electrodes 7 and bus electrodes 8, a visible light is emitted outside from the front panel 9 as a result of the luminescence of the luminescent materials such as 1R caused by the plasma discharge in the discharge gas and the picture element displays a color.

The protective film 5 covering the dielectric layer 6 is made of metallic oxide. In particular, it is desirous to form the protective film 5 using magnesium oxide (MgO). The protective film 5 is formed to have the following characteristic by the procedure to be explained later.

The protective film 5 is so formed that the basic structural unit of the structures is small and the film structure is minute. That is, each columnar structure growing and extending from the interface between the film and the dielectric layer toward the film surface direction forms a structural unit and the film is packed with a great number of the columnar structures. The number density of the columnar structures is made higher, where the number of the columnar structures to be formed is, for example, more than 400 per 1 μm² of the substrate area in the case the film thickness is 600 nm. It is possible that the number is more than 500 per 1 μm² of the substrate area in the case the film thickness is 100 nm. In the case the film thickness is 100 nm, the number can be increased to about 2500 per μm² of the substrate area or as much as about 3000. In the case the film thickness is 600 nm, the number can be increased to about 1500 per μm² of the substrate area or as much as about 2000.

Since the number density of the columnar structures to be formed on the protective film 5 is made higher, the surface area of the film becomes larger. Besides, the columnar structures comprising the protective film 5 is made grow directly from the interface with the dielectric layer 6 and a series of structures are formed up to the surface of the protective film 5.

Since a specific unit comprising the structure of the protective film 5 is made smaller and the structures are formed minutely as above, the physical and chemical stability becomes high enough. In addition, the protective film 5 is formed very closely onto the dielectric layer 6 that serves as the substrate of the film. Consequently, providing the protective film 5 as above is meaningful for the plasma display panel as follows.

With the protective film 5, the plasma display panel can be made more sputter resistive against the impact of ions in the discharge gas when the panel is operated. That is, since the number density of the columnar structures comprising the protective film 5 is made higher, the number of ions needed for scraping an atomic layer from the metallic surface of the protective film 5 increases, and hence the sputter resistance can be increased.

Besides, since the columnar structures of the protective film 5 is made grow directly from the interface with the dielectric layer 6 and a series of structures are formed, high sputter resistance can be realized at any portion of the protective film 5. In addition, since the surface area of the protective film 5 is wide, the secondary emission from the protective film 5 can be enhanced, and hence the secondary emission coefficient can be increased.

Since the protective film 5 has excellent sputter resistance and secondary emission characteristic as above, the protective film 5 can be made thinner. Since the protective film 5 can be made as thin as, for example, less than 300 nm, the time needed for manufacturing the plasma display panel can be reduced and the manufacturing cost can also be reduced.

Since the protective film 5 is closely packed with the structures as above, it is not necessary to carry out etching for forming concavity or convexity so as to increase the surface area of the protective film. Also for this reason, the time needed for manufacturing the plasma display panel can be reduced and the manufacturing cost can also be reduced.

Since the secondary emission coefficient of the protective film 5 is higher as above, the discharge breakdown voltage and discharge continuation voltage for operating the plasma display panel decreases, and hence the power consumption involved in the discharge can be reduced.

The crystal orientation of the protective film 5 along the normal can be any one of <111>, <220>, <100> and <311> or any combination of these to any ratio. When the protective film 5 is made of magnesium oxide (MgO), it is understood that the highest secondary emission from MgO crystals can be generated along the <111> crystal axis direction. Besides, an optional combination of the crystal orientation on the film enables to control the secondary emission characteristic.

Next, the procedure of forming the protective film 5 is explained hereunder.

The protective film 5 can be formed by a vacuum deposition device employing the ion plating method where the film material evaporated by the electron beam irradiation passes through a high-frequency coil and accumulates on a substrate (dielectric layer 6). This forming method, called MURAYAMA Method, is characteristic in it that the film material ionized in the space surrounded by the high-frequency coil accumulates on the substrate as it is accelerated by the negative bias voltage applied to the substrate.

Pellets of metallic oxide such as MgO are employed as the film material and, while supplying oxygen gas into the vacuum deposition room (vacuum chamber) of the vacuum deposition device, the protective film 5 comprising the metallic oxide is formed to a desired thickness on the substrate made of dielectric substance. In forming the protective film 5, oxygen gas supply is inevitable during the deposition. When the metallic oxide serving as the film material is evaporated by the electron beam irradiation, oxygen atoms are apt to desorb from the film material and consequently the film formed with no oxygen supply is apt to result in an oxygen deficiency state. For this reason, oxygen gas needs to be supplied on the growing surface of the film. Not only O₂ but O₃ may be supplied as the oxygen gas. By forming the film along with oxygen supply as above, the film can be made transparent enough for visible lights even if the film is formed as thick as about 600 nm.

The number density of the columnar structures comprising the protective film 5 can be increased by increasing the oxygen gas pressure. In view of the secondary emission coefficient and sputter resistance of the protective film 5, it is preferable that the oxygen gas pressure during the deposition is higher than 1.0×10⁻² Pa. This is because the secondary emission coefficient and sputter resistance can be improved with this gas pressure. It is more preferable that the oxygen gas pressure during the deposition is made higher than 4.5×10⁻² Pa. With this gas pressure, the secondary emission coefficient and sputter resistance of the protective film 5 can further be improved.

The secondary emission coefficient and sputter resistance of the protective film 5 in relation to the oxygen gas pressure during the deposition as explained above can be favorably realized when the deposition speed is made less than 5 nm per second. Even when the deposition speed is faster than 5 nm per second, the above-mentioned secondary emission coefficient and sputter resistance of the protective film 5 in relation to the oxygen gas pressure during the deposition can be maintained by increasing the substrate temperature, for example, to about 150° C. or higher.

On the protective film 5, the crystal orientations <111>, <220>, <100> and <311> can be achieved along the direction perpendicular to the substrate surface, but the ratio of the orientation <111> can be increased by increasing the oxygen gas pressure during the deposition. Since the crystal orientation depends also on the substrate temperature during the deposition, the orientation <111> can be made dominant by increasing the substrate temperature. Accordingly, the film with the orientation <111> can be achieved easily by adjusting the substrate temperature and oxygen gas pressure at the same time.

In depositing the metallic oxide as the protective film 5, the crystallinity of the film can be enhanced by increasing the oxygen gas pressure on the growing surface. A method available for increasing the oxygen gas pressure on the growing surface and hence decreasing the load to a vacuum exhaust device is to irradiate the oxygen gas as a beam that is directional towards the substrate.

In irradiating the oxygen gas as a directional beam, it is possible to irradiate the oxygen beam at an inclined angle towards the substrate so that the oxygen beam reflected on the substrate does not return directly to the oxygen inlet port but that the reflected oxygen beam enters directly into the exhaust port of the vacuum exhaust device. With this, the residual pressure of the oxygen gas in the vacuum deposition room can decrease.

Use of directional oxygen gas beam as above makes it possible to incline the moving direction of the oxygen gas, irradiated into the vacuum deposition room, from the gas inlet port towards the substrate. When the above oxygen gas beam is irradiated towards the substrate surface, the oxygen gas supply pressure itself can be increased up to about 1.0 Pa when measured on the, growing surface of the film.

To the contrary to the directional oxygen gas beam, oxygen gas with isotropic motion is not directional. While the state of this non-directional oxygen gas is called thermal equilibrium, the state of the oxygen gas with inclined moving direction is called non-equilibrium. Since the average motion energy of the oxygen gas in the non-equilibrium state is greater than the average motion energy in the thermal equilibrium state because of the difference in the generation process, the energy is effective to facilitate dissociation and oxidation of the oxygen gas on the growing surface.

To achieve homogeneous quality on the entire surface of the film made of metallic oxide, it is desirous that the oxidization is developed evenly on the entire growing surface. In developing the oxidization evenly on the entire growing surface, the divergence angle, beam pressure and number of the oxygen gas inlet ports of the oxygen beam can be adjusted.

The directional oxygen beam as explained above can be generated in the following manner. In the first step, oxygen gas pressurized to a desired pressure is jetted out from a very small hole. Controlling the shape and size of the small hole makes it possible to adjust the oxygen gas pressure on the growing surface. An optional gas may be added to the oxygen gas.

In the second step, only the center portion of the jetted oxygen gas is selected through another small hole and then is led into the vacuum deposition room. While increasing the number of times of selecting only the center portion of the oxygen gas makes it possible to gradually increase the non-equilibrium, i.e. directivity of the oxygen gas, it decreases the oxygen gas pressure gradually.

Passing the oxygen gas beam through the high-frequency coil placed in the vacuum deposition room and then irradiating it on the growing surface of the film accelerates the oxidization. In other words, exciting the oxygen gas beam efficiently to a highly reactive state with the aid of the high frequency makes it possible to accelerate the oxidation.

The oxygen gas beam can be either continuous or intermittent. An intermittent beam can be generated by chopping a continuous beam. Since use of the intermittent oxygen gas beam enables to increase the oxygen gas pressure, there may be a case where crystallization on the growing surface is further accelerated than a case where the continuous beam is used.

[Embodiments]

As an embodiment of the present invention, the protective film 5 made of metallic oxide covering the dielectric layer 6 of the front panel 9 that constitutes the plasma display panel is formed. In forming the protective film 5 of the embodiment, a vacuum deposition device of the ion plating method is employed, where the film material evaporated by the electron beam irradiation passes through a high-frequency coil and accumulates on a substrate.

With this forming method which is called MURAYAMA Method, the film material ionized in the space surrounded by the high-frequency coil accumulates on the substrate as it is accelerated by the negative bias voltage applied to the substrate.

MgO pellets are used as the film material and the protective film 5 made of MgO is formed on a dielectric glass substrate (dielectric layer 6). Then, the oxygen gas in the thermally equilibrium state is supplied at a pressure of 2.0×10⁻² Pa into the vacuum deposition room of the vacuum deposition device.

As another oxygen gas, an oxygen beam in the non-equilibrium state is also supplied into the vacuum deposition room. The oxygen beam in the non-equilibrium state is supplied in the following steps. Oxygen gas (O₂) is first pressurized to 1.0 kg/cm² and then is jetted out from a blowout hole of 0.5 mm in diameter. Next, the jetted out oxygen beam is passed through a screening hole called skimmer so as to select only the center portion of the beam. The skimmer has a screening hole of 1.0 mm in diameter. Then, the oxygen gas not selected through the skimmer is isolated and exhausted from the room so as not to enter into the vacuum deposition room.

The non-equilibrium of the selected oxygen beam can be controlled by adjusting the distance between the blowout hole and the screening hole. In forming the protective film 5 of the embodiment, the distance between the blowout hole and the screening hole is set to 5 mm. With this, the velocity of the selected oxygen beam is set to Mach 1.3.

Then, the oxygen beam is passed through the high-frequency coil and irradiated directly onto the substrate in a direction at 15 degrees to the normal of the substrate surface. The irradiation area of the oxygen beam on the substrate is about 2000 mm². The oxygen beam pressure is 3.5×10⁻¹ Pa. While the vacuum chamber pressure before the irradiation of the oxygen beam is 2×10⁻⁴ Pa, it increases to 2.0×10⁻² Pa during the irradiation of the oxygen beam.

In forming the protective film 5 of the embodiment, high frequency power of 1.5 kW is applied to the high-frequency coil. Besides, negative DC bias voltage is applied to the substrate and the voltage is set to 100 to 400 V. Also in forming the protective film 5, the glass substrate is heated to 150° C. by a substrate heater. Also in forming the protective film 5, the forming speed is set at 1.5 nm per second.

As the embodiment 1, the protective film 5 is so formed as to have the thickness of 100 nm. Then, as the embodiment 2, the protective film 5 is so formed as to have the thickness of 600 nm.

As a comparative sample, the protective film made of MgO is formed by the electron beam deposition method. In forming the protective film of the comparative sample, the oxygen gas at about 1.3×10⁻² Pa is supplied into the vacuum deposition room. The substrate temperature is set at 250° C. and the forming speed is set at 1 nm per second.

[Experiment 1]

Observation of the Structure of the Protection Film

Each protective film 5 of the embodiment 1, embodiment 2 and comparative sample is formed on the glass substrate and observed in the following procedure.

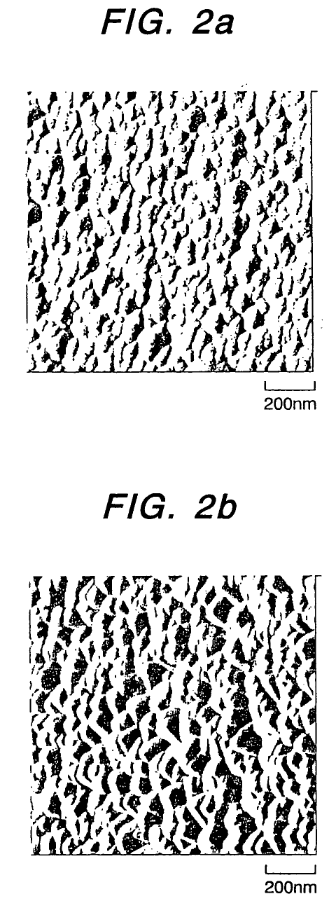

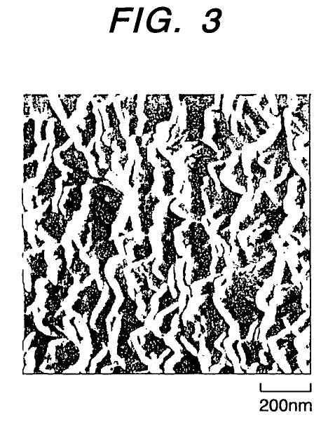

The structure of each protective film 5 of the embodiment 1, embodiment 2 and comparative sample is observed with an atomic force microscope and a scanning electron microscope. FIG. 2 and FIG. 3 show the observed image of the surface of the protective film 5 on an atomic force microscope. In each observed image in FIG. 2 and FIG. 3, the vertical and horizontal sides represents 1.0 μm each. FIG. 2a is an observed image of the embodiment 1 and FIG. 2b is an observed image of the embodiment 2. FIG. 3 is an observed image of the comparative sample.

In obtaining the images in FIG. 2 and FIG. 3, the observation condition is set as follows. The atomic force microscope is set to a contact mode and the surface of each protective film of the embodiments 1, 2 and the comparative sample is scanned with a probe at a speed of 1 Hz per 1 μm. The probe is of a needle type made of silicon and coated with gold. The spring constant of the probe is 0.12 N/m and the resonance frequency is 12 kHz.

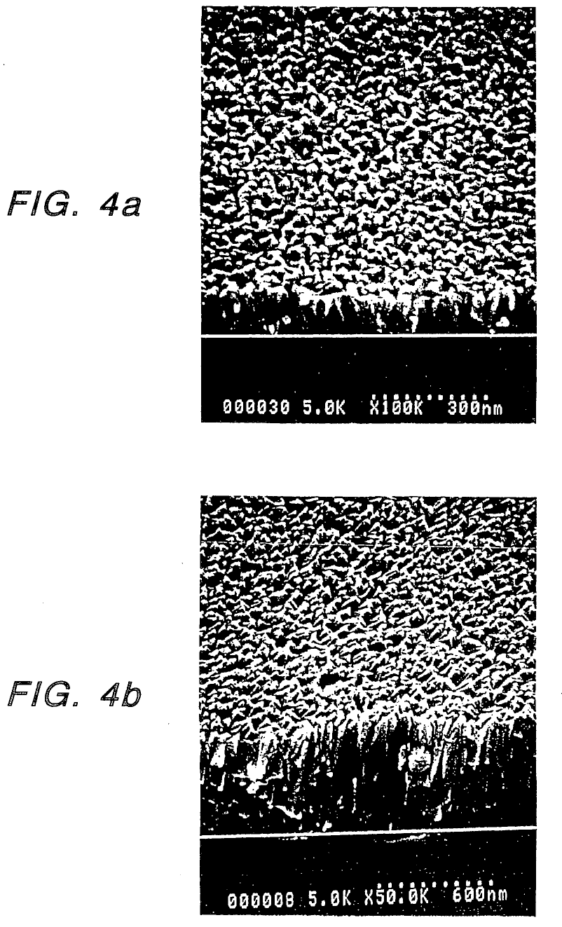

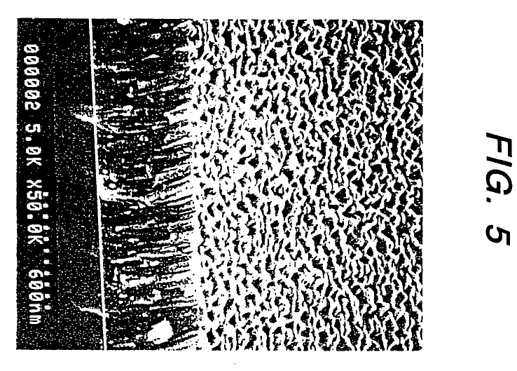

FIG. 4 is the observed images of the surface and cross section of the.protective film 5 on the scanning electron microscope. FIG. 4a is the observed image of the embodiment 1 and FIG. 4b is that of the embodiment 2. FIG. 5 is the observed image of the comparative sample.

The distance between the dots shown on the observed images in FIG. 4 and FIG. 5 represents 0.1 μm. In obtaining the images in FIG. 4 and FIG. 5, the observation condition is set as follows.

For each film obtained in the embodiment 1, embodiment 2 and comparative sample, the film together with the substrate is cut perpendicularly to the surface and the cut surface is provided with platinum sputter coating so as to prepare each specimen for the observation. The magnification of the observation is 100000× for the embodiment 1 , 50000× for the embodiment 2, and 50000× for the comparative sample. Each specimen is observed from an inclined direction at 60 degrees to the surface.

The structure of each protective film 5 of the embodiment 1 and embodiment 2 can be well observed in FIG. 2 and FIG. 4. That is, in the protective film 5 of each embodiment, the columnar structures have been formed, growing closely to each other, from the interface with the glass substrate almost perpendicularly towards the surface, and it is understood that the film is formed into a structure packed with a great number of columnar structures each of which serves as a columnar structural unit.

Besides, for each protective film 5 of the embodiment 1 and embodiment 2, the following can be understood from FIG. 2. That is, in each protective film 5 of the embodiment 1 and embodiment 2, the portion at the top surface of the columnar structures is formed into a pyramid crystal lump having sharp angles. Also in each protective film 5 of the embodiment 1 and embodiment 2, each columnar structure is formed with clear contour and adjacent columnar structures can be clearly distinguished into each block. Also in each protective film 5 of the embodiment 1 and embodiment 2, it is observed that the size and shape of the columnar structure are not so much different from each other.

For the protective film 5 of the embodiment 1, it is understood from FIG. 2a that the number of the columnar structures formed and exposed on the surface is more than 500 per the substrate area of 1 μm². Besides, for the protective film 5 of the embodiment 2, it is understood from FIG. 2b that the number density of the protrusions of the crystals exposed on the surface of a great number of the formed columnar structures is more than 400 per 1 μ².

In the protective film 5 of the embodiments 1 and 2 shown in FIG. 4, the columnar structures are formed almost in series from the interface with the glass substrate up to the surface and any intermittent portion is hardly observed halfway.

For the protective film of the comparative sample, on the other hand, it is observed from FIG. 3 that the number of the crystal columns per the substrate surface area of 1 μm² is about 200, which is less than the number in the embodiments. The structure of the protective film can be understood from FIG. 5. Even in the protective film of the comparative sample, the structures have been formed, growing from the interface between the protective film and the glass substrate towards the surface of the protective film, but the. structure with low crystallinity is formed near the interface with the glass substrate and no formation of columnar structure is observed. It, however, is understood from FIG. 5 that continuous structures with low crystallinity are formed near the interface with the glass substrate because the image observed is lower in the difference of contrast, and that the structures grow into columnar structures at portions closer to the surface of the protective film.

As a result of the comparison of FIG. 2 and FIG. 4 with FIG. 3 and FIG. 4 as above, it is understood that the protective film of the embodiment 1 and 2 have the following characteristics. That is, in the protective film of the embodiments, a unit comprising the structure is smaller and at the same time, is formed regularly, and the film is formed into minute structures. Also in the protective film of the embodiments, the columnar structures are formed directly from the interface with the substrate and have grown regularly and minutely.

[Experiment 2]

Measurement of Secondary Emission Coefficient

Each protective film 11 of the embodiment 1 and the comparative sample is formed on a stainless steel plate 10 and the secondary emission coefficient is measured as follows.

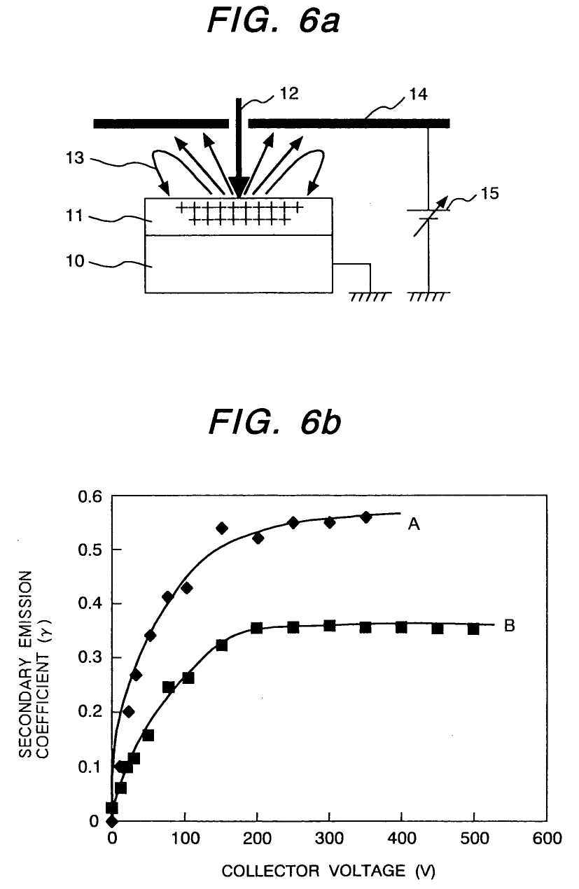

FIG. 6a is a schematic diagram of a secondary emission characteristic evaluating device employed for the measurement. With this secondary emission characteristic evaluating device, as shown in FIG. 6a, a Ne ion beam 12 is irradiated on the surface of the protective film 11 made of MgO formed on the stainless steel plate 10 so as to emit the secondary beam 13, and the secondary beam is collected by a collector 14 installed in front of the MgO protective film 11. While irradiating the Ne ion beam 12, the current (Ic) through the collector electrode 14 and the current (Is) through the substrate are measured using an ammeter (not shown). The secondary emission coefficient (γ) is obtained from the equation γ=Ic/(Is−Ic).

Besides, the bias voltage Vc is applied between the collector electrode 14 and the stainless steel plate 10 so that the potential of the collector electrode 14 becomes positive. Thus, the secondary electrons 13 emitted from the MgO protective film 11 are all collected. The secondary emission coefficient is obtained from the saturation current of the secondary beam 12 that is measured while increasing the voltage 15 applied to the collector electrode 14.

To measure the secondary emission characteristic, the Ne ion beam 12 is irradiated with the acceleration energy of 500 eV (electron volt). Measurement is made under the room temperature.

FIG. 6b, which is a chart of the measurement result, shows the collector voltage dependency of the secondary emission coefficient. In FIG. 6b, Characteristic A represents the characteristic of the embodiment 1 and Characteristic B represents that of the comparative sample. In FIG. 6b, the horizontal axis corresponds to the collector voltage and the vertical axis to the secondary emission coefficient (γ).

It is understood from FIG. 6b that the secondary emission coefficient (γ) of the embodiment 1 is about 0.55, that of the comparative sample is 0.35, which means the secondary emission coefficient of the embodiment 1 is greater than that of the comparative sample. From this fact, it is understood that use of the protective film of the embodiment 1 enables to reduce the discharge breakdown voltage and discharge continuation voltage in operating the plasma display panel.

[Experiment 3]

Measurement of Crystal Orientation

For the embodiment 1 and the embodiment 2, the crystal orientation is measured by means of X-ray diffraction. In the embodiment 1, the orientations <111> and <220> are observed. In the embodiment 2, the orientation <111> is only observed.

[Experiment 4]

Measurement of Sputter Resistance

For the embodiment 2 and the comparative sample, the sputter resistance is measured using argon plasma. A high-frequency magnetron sputter is employed as a sputtering device and argon gas at 0.5 Pa is supplied. Each specimen is covered with a mask made of tungsten having a slit of 1 mm in width and is placed at the same position as is the discharge electrode. Then, the specimen is exposed to argon plasma for an hour, using high frequency power of 100 W. In measuring the sputter resistance, an atomic force microscope is set to the same condition as in Experiment 1 and the amount of sputters is evaluated by measuring the difference at the mask boundary.

As a result, the amount of sputters in the embodiment 2 is less than half the amount in the comparative sample. It is understood from this result that the embodiment 2 has two times greater sputter resistance than the prior art. Considering that the typical thickness of the MgO film employed in a commercially available plasma display panel is about 600 nm, it is judged that the film of the embodiment has similar durability to a conventional film although the film thickness is only about 300 nm.

In the plasma display unit according to the present invention, as explained above, the protective film covering the dielectric layer is so formed that each columnar structure growing and extending from the interface between the film and the dielectric layer toward the film surface direction forms a structural unit and the film is packed with a great number of the columnar structures, and that the number density of the columnar structures is made higher. That is, a specific unit comprising the structure of the film is made smaller and a film with minute structures is formed.

With the plasma display panel equipped with the protective film according to the present invention, effects of excellent sputter resistance and secondary emission characteristic can be produced. As a result, the operating life of the plasma display panel can be extended and the manufacturing cost can be reduced, and also the power consumption can be reduced.

What is claimed is:

1. A plasma display panel of AC type including a front panel provided with display electrodes and a rear panel provided with address electrodes, for displaying an image by causing discharge in the discharge gas space formed between the front and rear panels;
wherein the display panel is provided with a protective film made of metallic oxide covering the dielectric layer placed on the front panel;
wherein the protective film is formed into a structure where columnar structures are densely packed, closely with each other, extending perpendicularly to the interface between the dielectric layer and the protective film; and more than 400 columnar structures are formed per the substrate area of 1 μm²

2. A plasma display panel according to claim 1, wherein the number of the columnar structures formed per the substrate area of 1 μm² is more than 500.

3. A plasma display panel according to claim 1, wherein the columnar structures are formed into a series of crystal structures from the interface with the substrate to the film

4. A plasma display panel according to claim 1, wherein the metallic oxide is magnesium oxide

5. A plasma display panel according to claim 1, wherein the film thickness to be formed as the protective film is less than 300 nm

6. A plasma display panel according to claim 1, wherein the film to be formed as the protective film is structured with one or more crystal axes, selected among a group of <111>, <220>, <100> and <311>, along the normal on the substrate surface.
